(19) United States
(12) Patent Application Publication
(10) Pub. No.: US 2014/0010078 A1
(43) Pub. Date: Jan. 9, 2014

(54) METHOD AND SYSTEM AND REDUCING CONGESTION ON A COMMUNICATION NETWORK

(71) Applicant: MOTOROLA MOBILITY LLC, (US)

(72) Inventor: Scott T. Droste, Crystal Lake, IL (US)

(73) Assignee: MOTOROLA MOBILITY LLC, Libertyville, IL (US)

(21) Appl. No.: 13/865,222

(22) Filed: Apr. 18, 2013

Related U.S. Application Data
(60) Provisional application No. 61/669,411, filed on Jul. 9, 2012.

(51) Int. Cl. H04W 28/02

(52) U.S. Cl. CPC H04W 28/0221
USPC 370/230

(57) ABSTRACT

To reduce the likelihood of APN congestion following a power restoration a UE that is communicatively linked to a network may delay its initial attach request to the communication network based on a function of a randomly generated number or on a hardware identifier that is unique or nearly unique to the UE. Examples of hardware identifiers that may be used include the UE's International Mobile station Equipment Identity (IMEI), the UE's International Mobile station Equipment Identity and Software Version number (IMEISV), and the UE's manufacturer serial number (MSN). Also, an operator-provided identifier, such as an International Mobile Subscriber Identity (IMSI), may be used.

### TECHNICAL FIELD

The present disclosure relates generally to network communication and, more particularly, to methods and systems for reducing congestion on a communication network.

### BACKGROUND

Congestion is a problem that all types of communication networks experience. It typically occurs when too many devices attempt to simultaneously access the same resources. In cellular networks, network congestion can take the form of Access Point Name (APN) congestion. An APN is an identifier used by a user equipment (UE) to identify a network resource when attempting to connect to a resource of the cellular network. For example, if the resource is a packet data network (PDN) network, the APN identifies the PDN and the service or services of the PDN required by the UE. Such services can include a connection to a wireless application protocol (WAP) server, a connection to a multimedia messaging service (MMS). APNs are used in many types of networks, including Third Generation (3G) data networks, general packet radio service (GPRS) networks, and long term evolution (LTE) networks. When it receives the APN from the UE, a network uses the APN to determine the type of connection to create for the UE. For example, the network may use the APN to determine what IP addresses should be assigned to the UE, what security methods should be used, and whether the UE should be connected to a private network. When too many UEs simultaneously request the same resources (e.g., the same radio and core network resources) of the cellular network, “APN congestion” is said to have occurred. There are several possible underlying causes of APN congestion, such as the network having insufficient network element capacity, memory, transaction processing capability, etc. to handle a sudden spike in the number of requests.

### BRIEF DESCRIPTION OF THE DRAWINGS

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

FIG. 1 is a wireless communication system in accordance with an embodiment of the invention, and FIG. 1a is one embodiment of an APN.

FIG. 2 is a schematic block diagram of a UE according to an embodiment of the invention.

FIG. 3 shows the format of an IMEI in accordance with an embodiment of the invention.

FIG. 4 shows the format of an IMEISV in accordance with an embodiment of the invention.

FIGS. 5-8 illustrate the results of various simulations.

FIG. 9 illustrates a process that a UE may carry out according to an embodiment of the invention.

### DETAILED DESCRIPTION

As previously discussed, APN congestion may be triggered by a variety of events. One example can be found in the context of Machine-Type Communication (MTC) devices. Although many MTC devices may be powered by batteries (or have a battery back-up system), it is anticipated that many will use the commercial power mains as their source of power. Examples of MTC scenarios that may use commercial power mains include in-home or in-business utility monitoring and reporting, i.e., “wireless meter reading,” vending applications, and the like.

It is not uncommon for many MTC devices (e.g., tens of thousands) to rely on the same network (e.g., a single cellular network) and to use the same source of commercial power. These MTC devices may, for example, be located in the same metropolitan area. However, if the commercial power source fails (due to a blackout, for example) and is then subsequently restored, then all of these MTC devices will simultaneously attempt to attach to the network to obtain the same resources. For example, the MTC devices may all attempt to connect to a server to relay diagnostic or telemetry data. The resulting flood of requests for the same resources may cause a network overload and cause APN congestion. The APN congestion would impact not only service to MTC devices, but also service to traditional mobile phone and data card users.

To reduce the likelihood of APN congestion following a power failure/restoration event, a UE (e.g., an MTC device) that is communicatively linked to a network may delay its initial attach request to the communication network. According to an embodiment of the invention, the length of this delay may be a function of a hardware identifier that is unique or nearly unique to the UE. Examples of values that may be used include the UE's International Mobile station Equipment Identity (IMEI), the UE's International Mobile station Equipment Identity and Software Version number (IMEISV), and the UE's manufacturer serial number (MSN). Also, an operator-provided identifier, such as an International Mobile Subscriber Identity (IMSI), may be used. Additionally, one or more of constituent parts of these values may be used. According to another embodiment of the invention, the length of time that the UE delays attachment to the network may be a function of a randomly generated number.

In various implementations, the delayed attach requests may be uniformly distributed over a network operator-defined period of time that takes into account the resources and capacity of the communication network.

In another embodiment of the invention, an operator of a communication network with which multiple UEs are communicating may establish prioritized groupings of UEs within the network as a function of one or more of a hardware identifier and generated random number of each of the UEs.

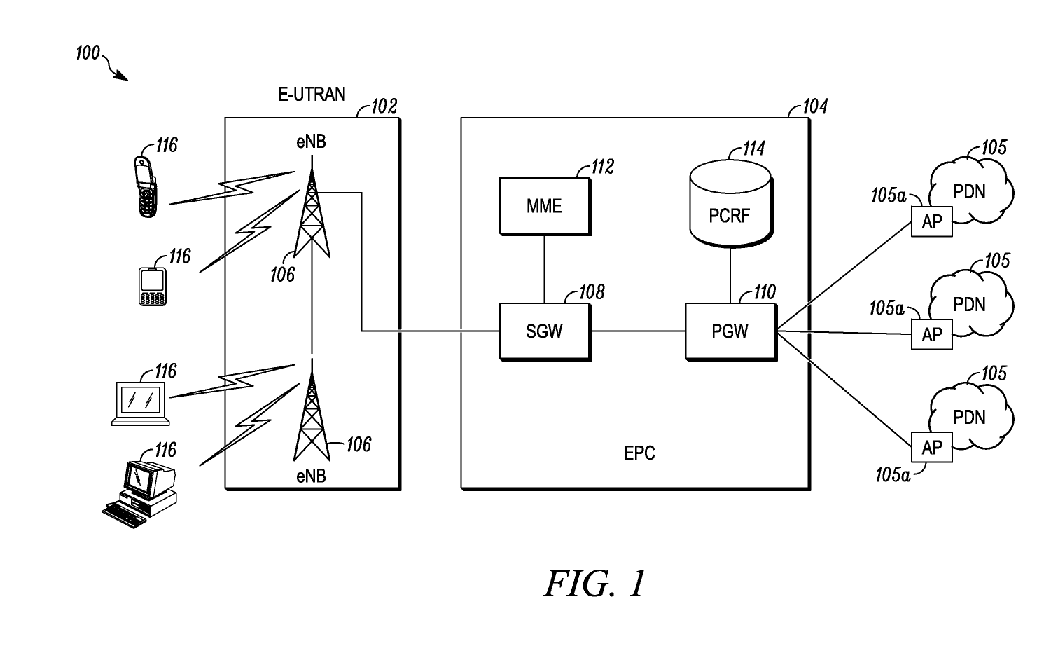

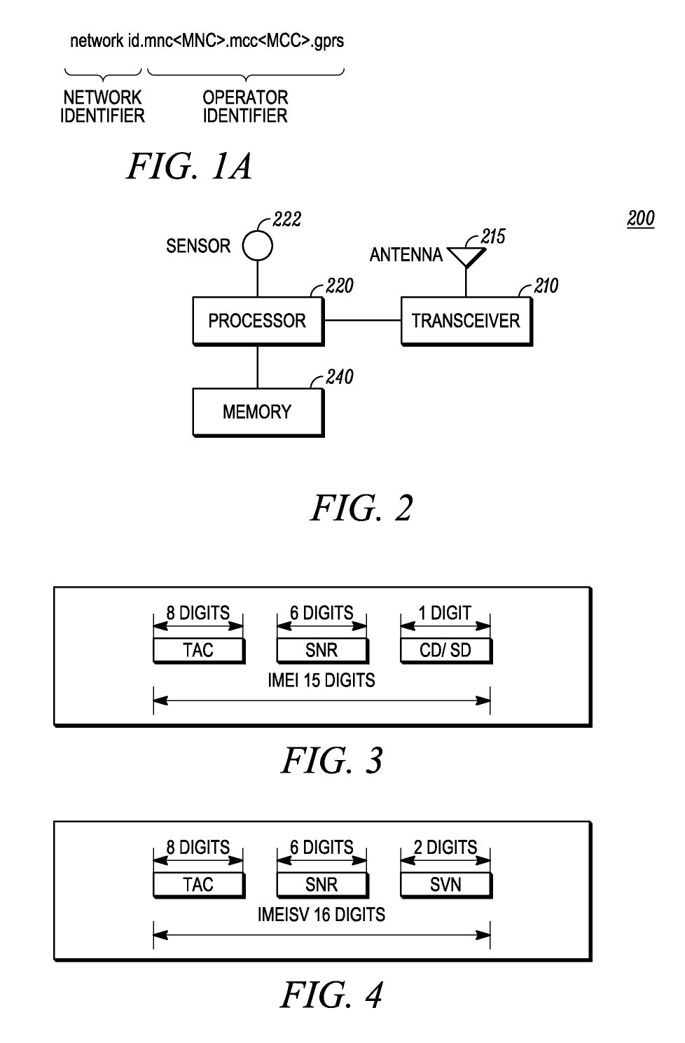

Turning now to FIG. 1, an example of an LTE communication system in which an embodiment of the invention may be employed will now be described. The communication system, generally labeled 100, comprises an evolved UMTS Terrestrial Radio Access Network (E-UTRAN) 102, an Evolved Packet Core network (EPC) 104, and Packet Data Networks (PDNs) 105. The EPC 104 is communicatively linked to the E-UTRAN 102. The E-UTRAN 102 includes enhanced Node base stations (eNB) 106, while the EPC 104 includes Serving Gateway (SGW) 108, a Packet Data Network gateway (PGW) 110, a Mobile Management Element (MME) 112, and a Policy and Charging Rules Function unit (PCRF) 114. The SGW 108 is communicatively linked to the E-UTRAN 102 as well as to the MME 112 and to the PGW 110. The PGW 110 is also communicatively linked to the PCRF 114 as well as to the PDNs 105. UEs 116 are communicatively linked to the eNBs 106.

The SGW 108 acts as an interface between the E-UTRAN and the EPC network 104. SGW 108 also maintains data paths between the eNBs 106 and the PGW 110. When, for example, one or more of the UEs 116 move from an area served by one of the eNBs 106 to an area served by another of the eNBs 106, data packets from the UE 116s are routed through SGW 108. The PGW 110 acts as an interface between the EPC 110 and the PDNs 105. The PGW 110 facilitates policy enforcement (e.g., by applying operator-defined rules for resource allocation and usage), packet filtering (e.g., deep packet inspection for application-type detection), and charging support (e.g., allowing an operator to carry out per-URL charging).

The MME 112 performs signaling and control functions to manage the UEs access to various portions of E-UTRAN 102 and the EPC 104. The MME 112 also assigns network resources to the UEs 116, and controls paging, roaming and handover functions and authentication of the UEs 116. When a UE 116 attempts to attach to the E-UTRAN 102, the MME 112 processes the request, including (1) checking a Home Subscriber Server (HSS) to determine whether the UE is permitted to access the E-UTRAN, and (2) authenticating the UE. The PCRF 114 supports applications that require dynamic policy and/or charging control.

The PDNs 105 include various types of entities, including public networks (such as the Internet) and private networks (such as cellular provider networks or networks used by corporations). One or more of the PDNs 105 may be accessed via a larger PDN, such as the Internet. Each of the PDNs 105 includes one or more Access Points (APs) 105a that controls access to the PDN 105. An AP 105a may be implemented in a number of ways, including as a gateway server.

The E-UTRAN 102 may be distributed over a geographical region. The UEs 116 communicate with one another, with UEs on other networks, with the EPC 104, and with the PDNs 105, among other entities, via the E-UTRAN 102. Such communication may occur in the time, frequency or spatial domain or a combination thereof.

It is to be understood that other types of devices may be used in place of the eNBs 106, including a generic access point, an access terminal, other types of base stations, a Home NodeB (HNB), a Home eNodeB (HeNB), a Macro eNodeB (MeNB), a Donor eNodeB (DeNB), a relay node (RN), a femtocell, a femto-node, a pico-cell, and a network node. Each eNB 106 may include one or more transmitters for downlink transmissions and one or more receivers for uplink transmissions.

Referring still to FIG. 1, there may be any number of eNBs 106 as well as any number of UEs 116. Each eNB 106 may serve a number of the UEs 116 within a corresponding serving area, for example, a cell or a cell sector, via a wireless communication link. The UEs 116 may be fixed or mobile. The UEs 116 may be implemented in many ways, including MTC devices, subscriber units, mobiles, mobile stations, mobile units, users, terminals, subscriber stations, user terminals, wireless communication devices, and relay nodes. Each of the UEs 116 includes one or more transmitters and one or more receivers. According to an embodiment of the invention, the eNBs 106 transmit downlink communication signals to the UEs 116 that are modulated using an orthogonal frequency division multiplexing (OFDM) scheme, and the UEs 116 communicate with the eNBs 106 via uplink communication signals modulated using a single carrier frequency division multiple access (SC-FDMA) scheme. The UEs 116 may also communicate with the eNBs 106 via a relay node.

Although FIG. 1 depicts an LTE system, the various embodiments described herein may also be applicable to other types of communication systems. More generally, embodiments of the invention may be implemented on a system that uses some other open or proprietary communication protocol, such as one of the IEEE 802.11 protocols, one of the CDMA protocols, UMTS, and GSM. The system may, for example, use spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading. Various embodiments may also be based on simpler time and/or frequency division multiplexing/multiple access techniques, or a combination of these various techniques. In alternate embodiments, the wireless communication system may employ other communication protocols including, but not limited to, TDMA or direct sequence CDMA. The communication system may also be a Time Division Duplex (TDD) or Frequency Division Duplex (FDD) system.

The UEs 116 may be implemented as devices that communicate using MTC or Machine-to-Machine (M2M) communications.

To communicate with one or more of the PDNs 105 and access resources therein in an embodiment of the invention, a UE 116 identifies the appropriate PDN 105 by using an APN associated with the PDN 105. More specifically, the UE 116 uses the address of the AP 105a that controls access to the desired PDN 105. In one embodiment, an APN is structured as shown in FIG. 1a. The APN in this example has two parts: (1) a network identifier, which indicates the external network in which the desired PDN is located, and which may also define the resource requested by the UE 116; and optionally (2) the operator identifier, which indicates the operator's PDN (e.g., the owner of the PDN 105) in which the resource is located. An MCC (mobile country code) identifying the country in which the PDN 105 is located and an MNC (mobile network code) which identifies which mobile network controls the PDN 105. Together, the MCC and the MNC may uniquely identify a mobile network operator (e.g., a cellular service provider). An example of an APN is “tmobile.internet.” One example of APN congestion is when too many UEs 116 are attempting to access the same resource on the same PDN 105 via the same AP 105a (i.e., they are all using the same APN).

FIG. 2 illustrates a possible implementation of the UEs 106 of FIG. 1. The UE, generally labeled 200, includes a transceiver 210 communicatively linked to a processor 220 and to an antenna 215. The processor 220 is communicatively linked to a sensor 222, which senses whether power has been restored to the UE following a power loss. The UE 200 implements a wireless communication protocol, as discussed above, and may be capable of conducting circuit or packet switched communications or both. In one embodiment, the processor 220 is implemented as a digital processor that executes instruction stored in one or more memory devices 240 to perform the functionality described herein. The processor 220 may also be a baseband processor or an application processor, or some combination of the two. Alternatively, the processor 220 may be implemented as an equivalent hardware circuit or as a combination of hardware and software. In one embodiment, various aspects of which are described further below in the context of an LTE communication system, the UE 200 is a Discrete Fourier Transform-Spread-Orthogonal Frequency Division Multiple Access (DFT-S-OFDMA) device. Alternatively, the UE 200 may implement one or more other protocols.

In an embodiment of the invention, the length of time that each UE 116 of FIG. 1 waits to attach to the E-UTRAN 102 is a function of its hardware identifier. For example, the UE's hardware identifier may be used as an input to an algorithm that calculates a back-off timer value for the UE's initial attach request to the communication network 102 following a power-failure/power-restoration event. The hardware identifier may be unique to each of the UEs 106. In one embodiment, a 3GPP defined IMEI or IMEISV is used as the unique hardware identifier. Other unique identifiers could be used as well. For example, an MSN could be used. Also, an operator-provided identifier, such as an IMSI, could be used.

In another embodiment of the invention, each UE 116 may generate a random number as an input to an algorithm that calculates a back-off timer value for the UEs initial attach request following a power-failure/power-restoration event.

In yet another embodiment of the invention each UE 116 may use its hardware identifier and/or a random number generator to enable an operator of the E-UTRAN to establish prioritized groupings of UEs within the network. This enables the operator to permit UEs with higher priority to attempt to attach to the E-UTRAN prior to lower priority UEs making an attempt.

Other procedures may be implemented in conjunction with any of the aforesaid techniques. For example, in an embodiment of the invention, each UE 116 (FIG. 1) is provided with parameters to control the time period over which the UE 116 should attempt a network attach procedure following a power failure/restoration event. These parameters may be provided by the operator of the E-UTRAN 102 to the UEs 106 (by downlink signal from an eNB 106, for example). Such parameters may include one or more of a minimum time a UE 116 may delay its attach attempt and a maximum time that the UE 116 may delay its attach attempt. These parameters may also be provisioned in the UE 116 at the time of manufacture, or through an over the air provisioning mechanism such one or more of those defined by Open Mobile Alliance Device Management (OMA DM). Additionally, the parameters may be provided through non-access stratum network signaling such as during a previous attach attempt or tracking area update procedure. In each case, the UE may retain the most recently provisioned parameter values in non-volatile memory (such as the one or more memory devices 240 of FIG. 2) so that the parameter values are available to the UE 116 following a power failure/restoration event.

In any of the above-described embodiments, the UE 116 (FIG. 1) may be configured to detect a power failure/power restoration event. The UE 116 may accomplish this by checking its last power-down status indicator to determine if the most recent power-down event was due to loss of power or by a normal power-down or power cycle due to maintenance (such as would possibly occur following a software update of the UE 116).

As previously discussed, some embodiments of the invention rely on the use of the IMEI of one or more of the UEs 106 as an input to an algorithm that produces a back-off timer value for attach requests following a power-failure/power-restoration event. Referring to FIG. 3, an example of a possible implementation of an International Mobile station Equipment Identity (IMEI) will now be described. The IMEI is composed of the following elements (each element having decimal digits): a Type Allocation Code (TAC) (8 digits long); a Serial Number (SNR) uniquely identifying each UE within the TAC (6 digits long); and a Check Digit (CD)/Spare Digit (SD), which is used to determine if preceding digits are entered correctly. In some embodiments, the SNR alone could be input into the algorithm.

As an alternative to the use of the IMEI, the UE's International Mobile station Equipment Identity and Software Version Number (IMEISV) may serve as an input to the attach back-off timer algorithm. Referring to FIG. 4, an example of a possible implementation of an IMEISV will now be described. The IMEISV includes the following elements (which may use decimal digits): a Type Allocation Code (TAC) (8 digits long); a Serial Number (SNR), which uniquely identifies each UE within each TAC (6 digits long); and a Software Version Number (SVN), which identifies the software version number of the UE 116 (2 digits long).

An example of an algorithm that a UE 116 may execute (e.g., on the processor 220 of FIG. 2) to calculate a back-off time will now be described. The algorithm uses ‘N’ of the least significant digits of either the IMEI or IMEISV along with a minimum time delay to spread the attach requests of the UE 116 between a minimum and a maximum time delay.

$${T}_{Backoff} ( N , IMEI ) = {T}_{Min} + ⌊ ( \frac{{V}_{IMEI} ( N )}{{10}^{N} - 1} ) \times ( {T}_{Max} - {T}_{Min} ) ⌋ \qquad [ 1 ]$$

Where T_{Backoff}(N,IMEI)=Time delay for initial attach request of the UE following power restoration to the UE, in units of time, as a function of N least significant digits of the UE's IMEI or IMEISV (N, IMEISV if IMEISV is used); Tₘᵢₙ=Minimum delay for UE's initial request following power restoration, in units of time; T_{Max}=Maximum delay for the UE's initial request following power restoration, in units of time; N=Number of least significant digits of IMEI or IMEISV considered in the calculation; and V_{IMEI}(N)=Decimal value of “N” least significant digits of the UE's IMEI or IMEISV (V_{IMEISV}(N) if IEMEISV is used). This is equivalent to IMEI mod 10^{N} or IMEISV mod 10^{N}.

An example of how V_{IMEI}(N) is determined will now be described. Assuming the IMEI value is 356914023690342, then the processor 220 (FIG. 2) retrieves the IMEI value from the memory 240 and inputs the IMEI value into equation, then

V_{IMEI}(3)=342 , V_{IMEI}(5)=90342, V_{IMEI}(10)=4023690342, etc. [1]

V_{IMEISV}(N) may be calculated in a similar fashion.

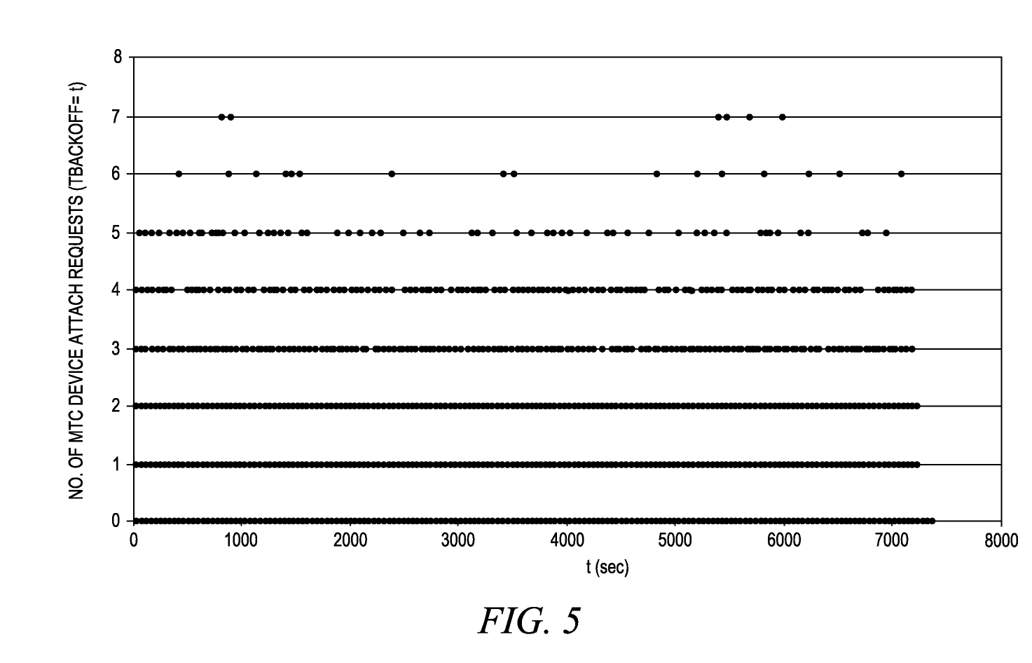

An example of the impact of various embodiments of the invention will now be described with respect to the simulation shown in FIG. 5. The simulation was conducted under the assumption that the UE would be implemented as an MTC device. The minimum delay for the initial attach request was set at T_{Min}=15 sec. In other words, it was assumed that no MTC device would attempt to transmit an attach request to the communication network within the first 15 sec after power restoration. The maximum delay for the initial request was set at Tₘₐₓ=7200 sec. In other words, it was assumed that all MTC devices would have completed their attach requests within 7200 sec (2 hrs) following power restoration. The number of least significant digits of IMEI considered in calculation N=6. The number of MTC devices in network was set to 10,000, while the number of unique TAC codes was set at 5. The number of TAC codes may represent the number of different device manufacturers or device models within the network.

FIG. 5 illustrates the results of the simulation, showing the distribution of MTC device attach requests over the interval from 15 s to 2 hrs. The results show that, at most, the network can expect 7 attach requests over any one second interval in the period from T_{Min} to T_{Max}.

Table 1 shows the rate of occurrence for a given number of MTC device attach requests per second over the time period of the simulation. The table shows that 25.17% of the time, a network can expect no MTC devices to attempt an attach request for any one second interval over the time period. Similarly, 34.50% of the time, it can expect one MTC device attach request over a given one second interval.

| Number of MTC Device | | |
|---|---|---|
| Attach Requests per | | |
| second over interval from | Number of Times | Rate of |
| T_{Min} to T_{Max} (15 s-2 hrs) | Occurring | Occurrence |
| 0 | 1809 | 25.17% |
| 1 | 2479 | 34.50% |
| 2 | 1698 | 23.63% |
| 3 | 801 | 11.15% |
| 4 | 303 | 4.22% |
| 5 | 72 | 1.00% |
| 6 | 18 | 0.25% |
| 7 | 6 | 0.08% |
| 8 | 0 | 0% |
| 9 | 0 | 0% |

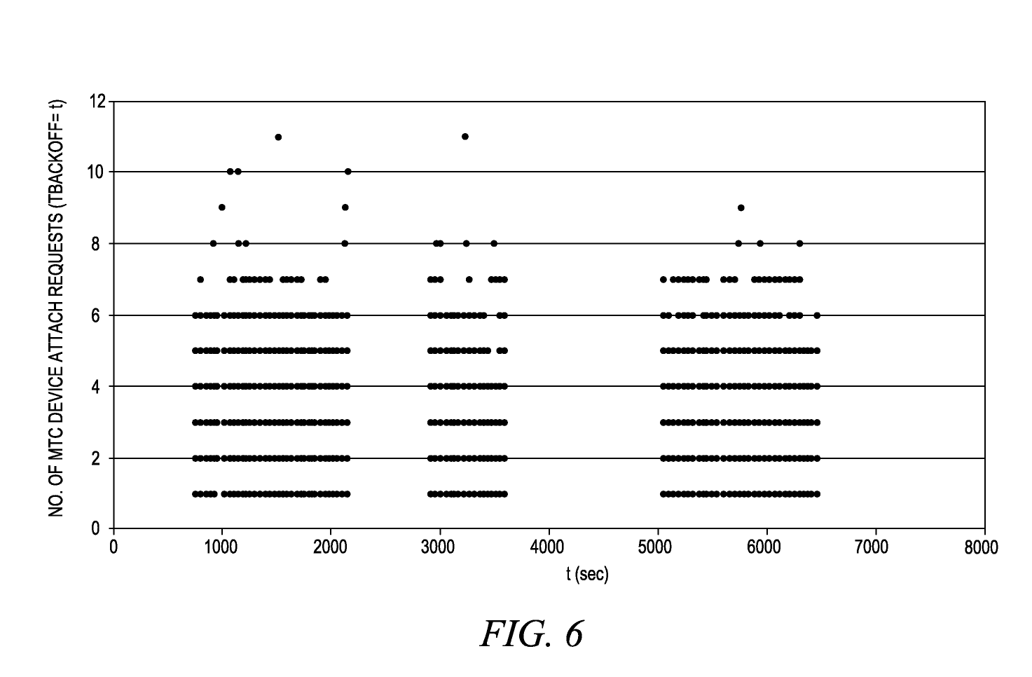

As can be seen, when the value of N exceeds 7 and the number of unique TAC codes present in the MTC devices within an operator's network is small, the values of T_{Backoff} tend to center about values influenced by the lower order digits of the TAC codes. This is illustrated in FIG. 6.

Although the previous description focused on the use of IMEI or IMEISV as the input to the calculation of T_{Backoff}, it is understood that other manufacturer hardware identifiers or operator provisioned identifiers could be used as an input to the algorithm. In particular, it should be noted that wireless networks operating in accordance with specifications developed by Third Generation Partnership Project 2 (3GPP2) make use of the MEID (Mobile Equipment Identifier) as the unique terminal hardware identifier. For terminals that may operate in both 3GPP and 3GPP2 networks, a single MEID is provisioned in the device (e.g., in the memory 240 of the UE 200 of FIG. 2) and shares a common format with IMEI—being composed of decimal digits. However, for devices designed to operate solely in 3GPP2 networks, the MEID is composed of hexadecimal digits. As such, the previously provided example algorithm for calculating T_{Backoff} could be modified to accommodate the MEID hexadecimal format, and would take the form:

$${T}_{Backoff} ( N , MEID ) = {T}_{Min} + ⌊ ( \frac{{V}_{MEID} ( N )}{{16}^{N} - 1} ) \times ( {T}_{Max} - {T}_{Min} ) ⌋ \qquad [ 2 ]$$

where T_{Backoff}(N,MEID)=Time delay for initial attach request following power restoration, in units of time, as a function of N least significant hexadecimal digits of UE's MEID; T_{Min}=Minimum delay for initial request following power restoration to the UE, in units of time; T_{Max}=Maximum delay for initial request following power restoration to the UE, in units of time; N=Number of least significant hexadecimal digits of the UE's MEID considered in calculation; and V_{MEID}(N)=Decimal value of “N” least significant hexadecimal digits of MEID.

An example of how to determine V_{MEID}(N) will now be described. Assuming that the MEID value is A0000002261F342, equation [2] would be evaluated to:

V_{MEID}(3)=834, V_{MEID}(5)=127810, V_{MEID}(10)=576844610, etc.

As an alternative to the use of a hardware identifier to uniformly distribute the value of T_{Backoff} for a given UE (e.g., an MTC device) over the range from T_{Min} to T_{Max}, the UE device may use a locally generated random number as input to an algorithm for calculating T_{Backoff}. An example of such an algorithm is shown below:

T_{Backoff}=Tₘᵢₙ+└rand(0,1)×(Tₘₐₓ−Tₘᵢₙ)┘ [3]

where T_{Backoff}=Time delay for initial attach request following power restoration, in units of time; T_{Min}=Minimum delay for initial request following power restoration, in units of time; T_{Max}=Maximum delay for initial request following power restoration, in units of time; and rand(0,1)=Random number between 0 and 1.

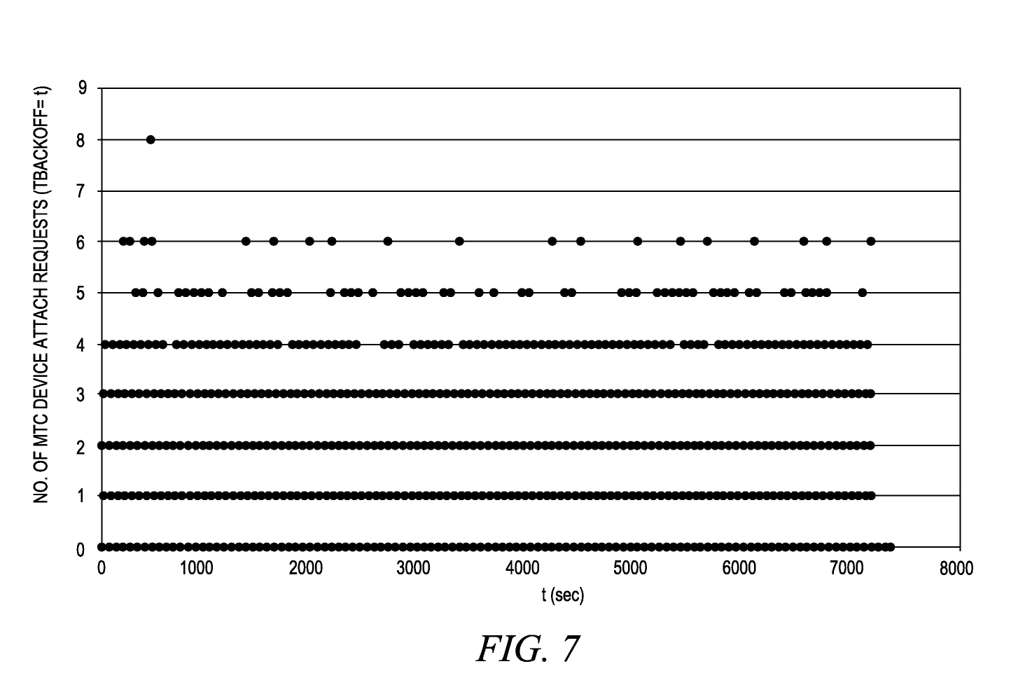

FIG. 7 illustrates the results of a simulation that shows the distribution of MTC device attach requests over the interval from 15 s to 2 hrs using the previously described random number-based algorithm. The results show that, at most, the network can expect 8 attach requests over any one second interval in the period from T_{Min} to T_{Max}.

Table 2 shows the rate of occurrence for a given number of MTC devices attach requests per second over the time period of the simulation. The table shows that 24.63% of the time, a network can expect no MTC devices to attempt an attach request for any one second interval over the time period from T_{Min} to T_{Max}. Similarly, 35.19% of the time, it can expect one MTC device attach request over a given one second interval.

| Number of MTC Device | | |
|---|---|---|
| Attach Requests per | | |
| second over interval from | Number of Times | Rate of |
| T_{Min} to T_{Max} (15 s-2 hrs) | Occurring | Occurrence |
| 0 | 1770 | 24.63% |
| 1 | 2529 | 35.19% |
| 2 | 1694 | 23.57% |
| 3 | 799 | 11.12% |
| 4 | 307 | 4.27% |
| 5 | 66 | 0.92% |
| 6 | 20 | 0.28% |
| 7 | 0 | 0% |
| 8 | 1 | 0.01% |
| 9 | 0 | 0% |

Another embodiment of the invention allows an operator to establish priority groupings of UEs (e.g., MTC devices) within its communication network. This enables an operator to ensure that UEs considered of higher priority re-establish connectivity to the network in advance of lower priority devices following a power failure/restoration event. For example, a network operator may desire that UEs performing more critical tasks, such as theft detection, attach to the network in advance of less critical tasks, such as wireless meter reading.

This may be achieved by assigning each UE a priority value, p, from the set of assignable priority values {1,2, . . . , p_{Max}}. Upon restoration of power following a power failure, the MTC device could use the assigned priority value in algorithm for determining the value of T_{Backoff}(p). Upon the expiration of T_{Backoff}(p), the UE would perform an attach procedure with the serving network.

To ensure more uniformity of UE attach requests over time, the algorithm for calculating T_{Backoff}(p) may incorporate aspects of the techniques previously described using either a hardware identifier or a random number generator within the UE.

An example algorithm for determining T_{Backoff}(p) using a random number generator is provided below:

$${T}_{Backoff} ( p ) = {T}_{Min} + ⌊ [ ( p - 1 ) + rand ( 0 , 1 ) ] \times [ \frac{{T}_{Max} - {T}_{Min}}{{p}_{Max}} ] ⌋ \qquad [ 4 ]$$

where T_{Backoff}(p)=Time delay for initial attach request following power restoration, in units of time, as a function of assigned priority of UE; p. T_{Min}=Minimum delay for initial request following power restoration, in units of time; T_{Max}=Maximum delay for initial request following power restoration, in units of time; rand(0,1)=Random number between 0 and 1; and p=Assigned priority of U, where p ∈ {1,2, . . . , p_{Max}}. A lower value of p indicates higher priority. Finally p_{Max}=Maximum value of assigned priority values (integer).

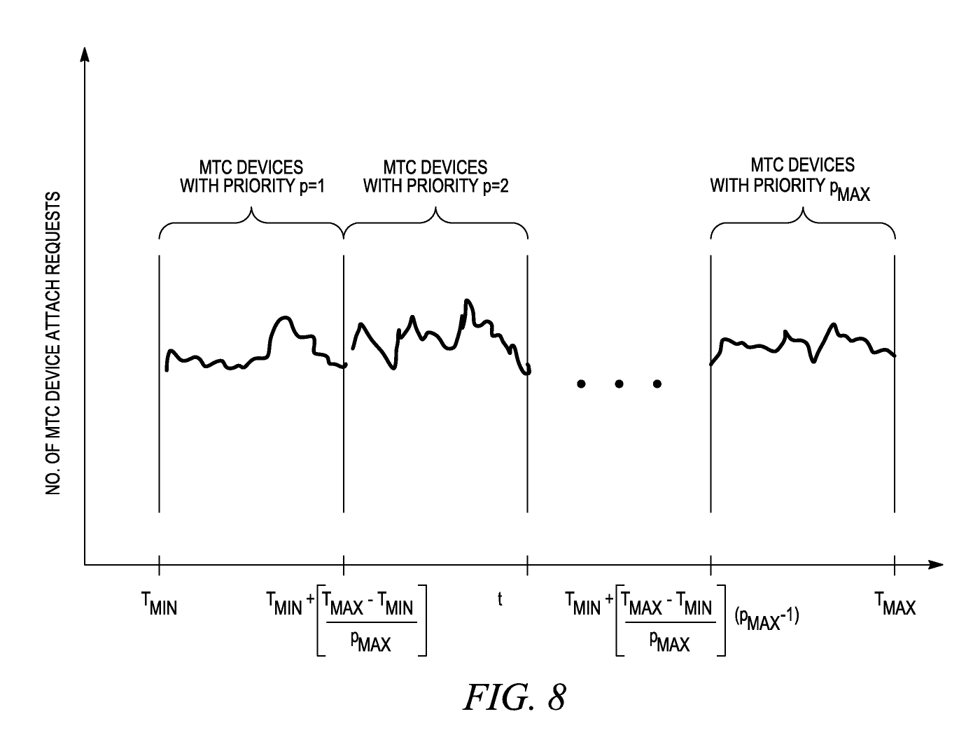

As stated, the above embodiment allows the operator to distribute the UEs attach attempts over time and assign each MTC device to a priority class. The effect of this embodiment is shown in FIG. 8, which illustrates the grouping of MTC attach requests that are assigned by priority value.

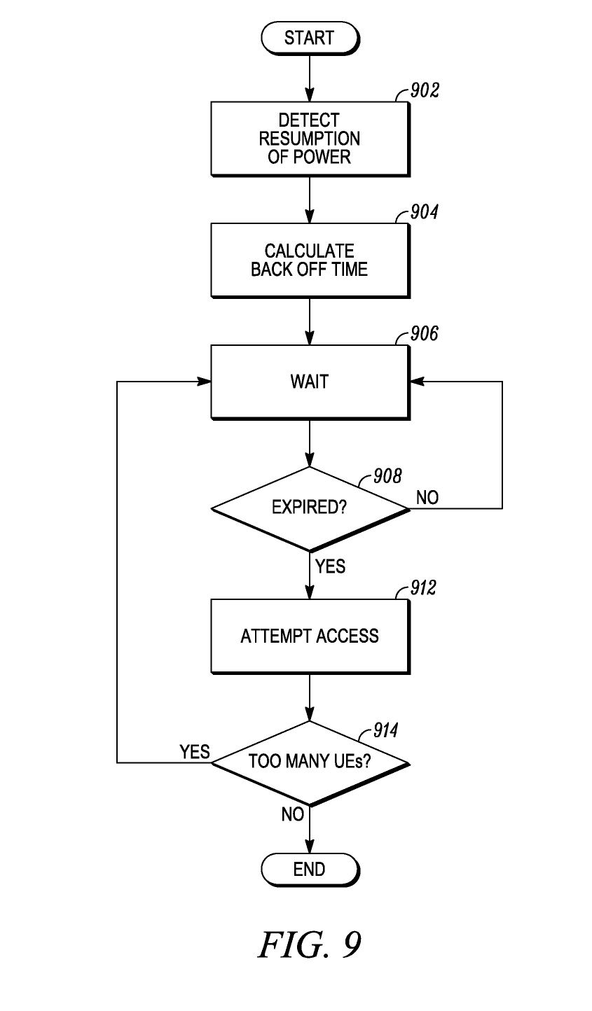

Referring to FIG. 9, with appropriate reference to FIG. 1, an example of a procedure that may be used to reduce APN congestion according to an embodiment of the invention will now be described. It is assumed that the UE 116 has initially detected a loss of power (e.g., based on a signal received from the sensor 222). At step 902, the UE 116 detects a resumption of power (e.g., based on a signal from the sensor 222). At step 904, the processor 220 of the UE 116 calculates a back off time according to one or more of the embodiments described above. The processor 220 may obtain the algorithm (and any other instructions need to perform the steps of the flowchart) from the memory 240. At step 906, the UE 116 waits. If, at step 908, the back off time has not expired, the process loops back step 906. If the back off time has expired, then, at step 912, the UE 116 attempts to attach to the E-UTRAN. For example, the UE 116 may transmit an attach request that identifies a resource of a PDN 105 by APN. If, at step 914, the requested resource is unavailable (due to, for example, an excessive number of UEs 116 attempting to access the resource following a power restoration), then the attachment request will be denied. In such case, the process loops back to step 906. If, on the other hand, the UE 116 successfully attaches to the E-UTRAN 102 and is able to access the requested resource of the PDN 105, then the process ends.

The present disclosure illustrates the architecture, functionality, and operation of possible implementations of systems and methods according to various embodiments of the present invention. In this regard, procedures outlined in the disclosure (for example, in flowchart of FIG. 9) may be implemented as a module, segment, or portion of code, which comprises one or more executable instructions for implementing the specified functions (e.g., on the processor 220 in combination with the memory 240 of FIG. 2). Furthermore, the simplified block diagrams (e.g., FIGS. 2 and 3) may be modified or added to without departing from the embodiments described here.

It should also be noted that, in some alternative implementations, functions noted in this disclosure may occur out of the order noted in the figures (e.g., in the flowchart of FIG. 9) or in the text. For example, two steps shown or described in succession may, in fact, be executed substantially concurrently, or the steps may sometimes be executed in the reverse order, depending upon the functionality involved.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are set forth in the appended claims.

We claim:

1. A method for reducing congestion on a communication network following a power failure, the method comprising:
detecting a restoration of power;
calculating a time delay based on a randomly generated number; and
in response to detecting the power restoration, attempting to access a network upon expiration of the time delay.

2. The method of claim 1, wherein the calculating step is further based on a priority value associated with a category of a message that is to be transmitted to the network upon gaining access to the network.

3. The method of claim 1, wherein attempting to access a network comprises attempting to attach to a radio access network.

4. The method of claim 3, wherein attempting to access a network further comprises
transmitting a request for a resource of a packet data network communicatively linked to the radio access network;
receiving a message indicating that the requested resource is not available;
waiting for a period of time based on the calculated time delay; and
repeating the waiting step until receiving a message indicating that the requested resource is available.

5. The method of claim 3, wherein attempting to access a network further comprises
transmitting a request for access to a packet data network communicatively linked to the radio access network,
receiving a message indicating that access to the packet data network is denied,
waiting for a period of time based on the calculated time delay, and
repeating the waiting step until receiving a message indicating that access to the packet data network is granted.

6. The method of claim 1, further comprising receiving from the network one or both of a minimum and maximum value for the time delay.

7. A method for reducing congestion on a communication network following a power failure on a user equipment, the method comprising:
detecting a restoration of power of the user equipment;
calculating a time delay based on a value associated with the user equipment; and
in response to detecting the power restoration, attempting to access a network upon expiration of the time delay.

8. The method of claim 7, wherein the detecting, calculating and attempting steps are performed by the user equipment, and the calculating step is further based on a priority value associated with the user equipment.

9. The method of claim 7, wherein the network has an access point associated with it, and the attempting step comprises transmitting a message containing a name of the access point.

10. The method of claim 7, wherein the value is an IMEI of the user equipment.

11. The method of claim 7, wherein the value is an IMEISV of the user equipment.

12. The method of claim 7, wherein the value is an IMSI of the user equipment.

13. The method of claim 7, wherein the value is an MSN of the user equipment.

14. A communication device comprising:
a memory having a plurality of instructions stored therein,
a processor communicatively linked to the memory, wherein the processor executes the instructions to carry out steps comprising:
detecting a restoration of power;
calculating a time delay based on a randomly generated number; and
in response to detecting the power restoration, attempting to access a network upon expiration of the time delay.

15. The device of claim 14, further comprising a sensor communicatively linked to the processor, wherein the processor detects the restoration of power based on signals received from the sensor.

16. A communication device comprising:
a memory having a plurality of instructions stored therein,
a processor communicatively linked to the memory, wherein the processor executes the instructions to carry out steps comprising:
detecting a restoration of power of the user equipment;
calculating a time delay based on a value associated with the user equipment; and
in response to detecting the power restoration, attempting to access a network upon expiration of the time delay.

17. The device of claim 16, further comprising a sensor communicatively linked to the processor, wherein the processor detects the restoration of power based on signals received from the sensor.

18. The device of claim 16, wherein the value is assigned to the user equipment by a radio access network with which the communication device is communicating.

19. The device of claim 16, wherein the value is stored in the memory at the time of manufacture of the communication device.
